(19) United States
(12) Patent Application Publication
(10) Pub. No.: US 2010/0095540 A1
(43) Pub. Date: Apr. 22, 2010

(54) CONSTRUCTION HOLE ALIGNMENT DEVICES AND METHODS THEREFOR

(76) Inventors: Samuel Berkman, Point Pleasant Boro, NJ (US); Kenneth S. Blumenthal, West Orange, NJ (US)

Correspondence Address: Doherty IP Law Group LLC, 37 Belvidere Ave, Washington, NJ, 07882, US

(21) Appl. No.: 12/548,848

(22) Filed: Aug. 27, 2009

Related U.S. Application Data
(60) Provisional application No. 61/196,328, filed on Oct. 16, 2008.

(51) Int. Cl. G01C 15/10; G01B 1/00

(52) U.S. Cl. 33/286; 33/392; 33/301

(57) ABSTRACT

A construction hole alignment device includes a tapered body having a smaller diameter first end, a larger diameter second end, and a series of stepped sections having progressively larger diameters extending between the first and second ends. The body has a central axis extending between the first and second ends, and the first end of the body includes a center aligned with the central axis. Each of the stepped sections has an annular outer wall. The tapered body includes flanges extending outwardly from the central axis for interconnecting adjacent stepped sections. The tapered body is insertable into a first construction hole until the outer diameter of one of the stepped sections matches the inner diameter of the first construction hole, whereby the center at the first end of the inserted body defines a target location for a second construction hole on a second floor.

### CROSS REFERENCE TO RELATED APPLICATIONS

The present application claims the benefit of U.S. Provisional Application Ser. No. 61/196,328, filed Oct. 16, 2008, the disclosure of which is hereby incorporated by reference herein.

### BACKGROUND OF THE INVENTION

1. Field of the Invention

The present invention generally relates to building construction, and more specifically relates to systems, devices and methods for aligning construction holes in buildings.

2. Description of the Related Art

Buildings often have multiple floors that are positioned one on top of another. In many instances, it is necessary to drill construction holes through the floors to pass items such as pipes, wires, cables, and conduits. A typical multi-story building may require the formation of thousands of construction holes. At least some of the construction holes are vertically aligned so that the pipes, wires, cables, and conduits may be efficiently passed between the floors of the building.

There are a number of conventional systems and devices used for aligning construction holes in buildings. FIG. 1 shows a conventional method for vertically aligning construction holes in a multi-story building. The building includes an upper floor 20 having a first construction hole 22 formed therein. The first construction hole 22 has a center 24. A first construction worker CW1, positioned adjacent the first construction hole 22, unwinds a length of string 26 from a stick 28 for lowering a weighted plumb bob 30 through the hole 22 and toward a top surface 32 of a lower floor 34. Simultaneously, a second construction worker CW2 guides the plumb bob 30 close to a target location 36 on the top surface 32 of the lower floor 34. The first construction worker CW1 then aligns the string 26 near the center 24 of the first construction hole 22 using a ruler 38. Once the string 26 is aligned with the center 24 of the first construction hole 22, the second construction worker CW2 marks the target location 36 on the lower floor 34 using a pointed end of the plumb bob 30.

Using the above-described method, the target location 36 on the lower floor 34 is aligned with the center 24 of the first construction hole 22. The target location 36 marked on the top surface 32 of the lower floor 34 is used to form a second construction hole in the lower floor 34 that is in vertical alignment with the first construction hole 22. During the construction of a typical multi-story building, the above-described procedure may be repeated thousands of times.

The above-described method of forming vertically aligned construction holes requires the cooperative effort of at least two construction workers, which is both time-consuming and costly. As labor rates for skilled construction workers are relatively high, the formation of thousands of construction holes in a multi-story building is very expensive. One alternative to the two-man method is to have a single construction worker travel between the upper and lower floors to mark the target location on the lower floor and then return to the upper floor to repeat the procedure for other holes.

An alternative method is to use a laser plumb bob device that projects a light beam on a target location. Laser plumb bob devices have had limited success, however, because the effort necessary to employ them without a hole center locating device is no better, or less convenient, than when using a conventional weighted plumb bob.

In view of the above, there remains a need for improved systems, devices and methods for efficiently and economically forming a plurality of aligned construction holes in buildings. There also remains a need for construction hole alignment devices that are extremely accurate for forming aligned construction holes throughout a multi-story building.

### SUMMARY OF THE INVENTION

In one embodiment, a construction hole alignment system includes a plurality of alignment devices that are adapted to be placed individually in each construction hole on a first level of a building so as to allow the center locations of each respective construction hole on the first level to be transferred to a second, lower level using a conventional weighted plumb bob, an optical laser plumb bob, or a laser alignment tool. In one embodiment, the plurality of construction hole alignment devices are adapted to be stored in a compact stack whereby the individual alignment devices are nested inside one another. As a result, a construction worker drilling the holes in a floor may store a plurality of the alignment devices on a tool cart and quickly insert a single alignment device in each construction hole to locate the center of each hole. Although the present invention is not limited by any particular theory of operation, it is believed that eliminating the need for a first construction worker for making ruler measurements for each hole while a second construction worker waits below to mark a target location will save time and money. Construction holes are frequently drilled through a wide range of materials including wood, metal, and concrete, and typically have diameters of between about ⅞ inches to about 10 inches. Typically, it takes about 10 minutes to drill a hole in concrete. Therefore, a non-skilled worker could retrieve, in a short time, the alignment devices that are no longer needed in the first construction holes because the next level construction holes' center positions could have been marked in about the time needed to drill one hole. In this manner, the driller need not run out devices.

In one embodiment, a construction hole alignment device may be used with conventional weighted plumb bobs, laser plumb bobs, or laser alignment devices. In one embodiment, the alignment device has a stepped, funnel-shape. Each of the stepped sections of the device may be made with straight or tapered outer diameters that are designed to fit popular sized construction holes. The devices may be stacked one inside the other for providing compact storage on a tool cart. In one embodiment, the center holes at the lower ends of the devices may be used as laser targets from above or below the device to project a beam for locating the center of a second construction hole on another level whose center is in alignment with the first hole.

In one embodiment, a first string having a fixed length or an adjustable length may be suspended from the centering hole of the alignment device to a convenient height above the floor level below. Then a second string, having a lower end connected to a conventional plumb bob or a laser plumb bob, may be affixed to a lower end of the first string. The length of the second string carrying the plumb bob may be fixed or adjustable. In one embodiment, a lower end of the first string includes a loop and an upper end of the second string includes a hook that preferably engages the loop for hanging the second string and the plumb bob from the first string.

In one embodiment, a construction hole alignment device includes a tapered body having a smaller diameter first end, a larger diameter second end, and a series of stepped sections having progressively larger diameters extending between the first and second ends of the body. The tapered body preferably includes a central axis extending between the first and second ends thereof, whereby the first end of the tapered body defines a center that is in substantial alignment with the central axis of the body.

In one embodiment, each of the stepped sections of the tapered body has an outer wall. In one embodiment, the outer wall is preferably annular shaped. The outer wall may also have a cylindrical shape, or may have a conical shape. In one embodiment, the outer wall has a cylindrical shape, and each of the cylindrical shaped outer walls has a respective center that is intersected by the central axis of the tapered body. In one embodiment, the outer walls have a conical shape that tapers slightly outwardly between the first end and the second end of the tapered body. In one embodiment, the conical shaped outer walls taper outwardly at an angle of about 1-5 degrees and more preferably about 1.75 degrees.

In one embodiment, a construction hole alignment device is adapted to be inserted into a construction hole located adjacent a vertically extending wall or an obstruction extending vertically from a floor. As such, in one embodiment, the outer wall of at least one of the stepped sections has a first curved section and a second substantially flat section that accommodates the vertical wall or the vertically extending obstruction. In one embodiment, the first curved section defines a first radius or distance from the central axis of the tapered body and the second substantially flat section defines a second distance or radius from the central axis of the tapered body, whereby the first distance to the curved section is greater than the second distance to the flat section. The smaller diameter flat section preferably provides space for the vertical wall or the vertical obstruction. In one embodiment, the substantially flat section extends over one or more adjacent stepped sections and along the length of the tapered body.

In one embodiment, the smaller diameter first end of the tapered body has a substantially closed end face with a central opening formed in the end face that is substantially aligned with the center of the first end and the central axis of the tapered body. In one embodiment, a string may be coupled with the central opening at the first end of the tapered body and a plumb bob may be secured to the string for hanging the plumb bob from the tapered body. In one embodiment, the length of the string may be adjustable for adjusting the spacing between the plumb bob and the first end of the tapered body. In one embodiment, the string may include a first section having a fixed length and a second section having an adjustable length. The plumb bob may be selected from a group of plumb bobs consisting of weighted plumb bobs and laser plumb bobs that project one or more light beams.

In one embodiment, the tapered body includes a first stepped section having a first annular wall with a first diameter, and a second stepped section having a second annular wall with a second diameter that is greater than the first diameter of the first annular wall. The tapered body preferably includes a first flange that interconnects an upper end of the first annular outer wall and a lower end of the second annular outer wall. The first flange desirably extends in a direction that is substantially perpendicular to the central axis of the tapered body. In one embodiment, the tapered body also includes a third stepped section including a third annular outer wall having a third diameter that is greater than the second diameter of the second annular outer wall. A second flange desirably interconnects an upper end of the second annular outer wall and a lower end of the third annular outer wall. In other embodiments, the tapered body may have a plurality of the above-described stepped sections having progressively larger diameters, whereby the outer walls of adjacent stepped sections are interconnected by flanges extending therebetween.

In one embodiment, at least two of the stepped sections define annular walls with respective centers that are aligned with the central axis of the tapered body. In one particular embodiment, the tapered body has a plurality of stepped sections and each of the stepped sections has a center that is aligned with the central axis of the tapered body.

In one embodiment, the alignment device includes a light emitting tool adapted to be placed on a surface of a floor which is located below the first end of a tapered body insertable in a construction hole. The light emitting tool desirably has a first light emitting element for projecting a first light beam in a first direction and a second light emitting element for projecting a second light beam in a second direction that is opposite the first direction.

In one embodiment, a construction hole alignment system includes one or more of the tapered bodies disclosed herein. In one embodiment, a construction hole alignment system includes a plurality of tapered bodies, which may be stackable atop one another. The tapered bodies are preferably made of materials such as plastic, rubber, paper, polymers and/or combinations thereof.

In one embodiment, a first construction hole is formed in the first floor and the alignment device described herein is inserted into the first construction hole so that the first end of the tapered body projects through the first construction hole. The center at the first end of the tapered body is used for positioning and aligning the light emitting tool. The first light beam is projected toward the first end of the tapered body so that it hits the center defined at the first end of the tapered body. The second light beam is then projected on the top surface of a second floor located below the first floor. The second light beam desirably highlights a target location on the second floor that is substantially aligned with the center at the first end of the tapered body. As a result, the first construction hole and the target location for the second construction hole are substantially aligned with one another. The target location on the second floor may be used as the center for forming a second construction hole. In one embodiment, the light emitting tool is placed on the lower floor and has an upwardly projecting light beam and an alignment feature for marking a target location on the lower floor.

In one embodiment, a construction hole alignment device used for aligning a first construction hole formed in the first floor with a second construction hole to be formed in a second floor includes a tapered body having a smaller diameter first end adapted for insertion into the first construction hole, a larger diameter second end, and a series of stepped annular shaped sections having diameters that are progressively larger between the first end of the tapered body and the second end of the tapered body. The tapered body preferably has a central axis extending between the first end of the tapered body and the second end of the tapered body. The first end of the tapered body preferably includes a center that is in substantial alignment with the central axis of the tapered body. In one embodiment, the construction hole alignment device desirably includes flanges interconnecting adjacent stepped sections, whereby the flanges are substantially parallel with one another and extend outwardly away from the central axis of the tapered body.

In one embodiment, a plurality of tapered bodies have substantially open second ends so that a first end of a first tapered body may be inserted into a second open end of a second tapered body for stacking at least two of the tapered bodies on top of one another. In one embodiment, a plurality of tapered bodies may be stacked atop one another for storage.

In one embodiment, a method of aligning construction holes includes forming a first construction hole in a first floor of a building, and inserting a tapered body into the first construction hole. The tapered body desirably has a smaller diameter first end, a larger diameter second end, a series of stepped sections having progressively larger diameters extending between the first and second ends of the tapered body, and a central axis extending between the first and second ends of the tapered body, whereby the first end of the tapered body includes a center that is in substantial alignment with the central axis of the tapered body. The method desirably includes inserting the first end of the tapered body into the first construction hole until an outer surface of one of the stepped sections closely engages an inner diameter of the first construction hole. After the tapered body is inserted into the first construction hole, the center at the first end of the tapered body is used for defining a target location on a second floor of the building, which is substantially aligned with the first construction hole. Various tools such a weighted plumb bob, a laser plumb bob, or a laser alignment device may be used in conjunction with the center at the first end of the tapered body for defining the target location on the second floor.

In one embodiment, a plurality of first holes may be formed in a first floor of a building so that tapered bodies as described herein may be inserted into the first construction holes in the first floors. After the tapered bodies are inserted into the first construction holes, the tapered bodies may be used for defining target locations on the second floor of the building that are aligned with the first construction holes. The above-described steps may be repeated for multiple floors in a multi-story building for forming aligned construction holes throughout the building.

In one embodiment, a method includes, hanging a first string from each of the tapered bodies insertable into first construction holes. A second string having a fixed length and carrying a plumb bob is preferably hung in sequence from each of the first strings to mark a plurality of target locations on the lower floor. As such, a single plumb bob on the second string may be used for marking a plurality of target locations. In one embodiment, the second string carrying the plumb bob has a fixed length. In one embodiment, the second string carrying the plumb bob has an adjustable length for accommodating different distances between adjacent floors. The first and second strings may be connected together using loops, hooks, or other well known securing elements.

These and other preferred embodiments of the present invention will be described in more detail below.

### BRIEF DESCRIPTION OF THE DRAWING

FIG. 1 shows a prior art method of aligning construction holes in a multi-story building.

FIG. 2A shows a prospective view of a construction hole alignment device, in accordance with one embodiment of the present invention.

FIG. 2B shows a front elevational view of the construction hole alignment device of FIG. 2A with a portion of the figure shown in cross-section.

FIG. 2C shows a top plan view of the construction hole alignment device of FIGS. 2A and 2B.

FIG. 3 shows the construction hole alignment device of FIGS. 2A-2C and a plumb bob string assembly used for hanging a plumb bob from the alignment device, in accordance with one embodiment of the present invention.

FIG. 4 shows a method of aligning construction holes using a construction hole alignment device, in accordance with one embodiment of the present invention.

FIG. 5 shows a method of aligning construction holes using a construction hole alignment device, in accordance with one embodiment of the present invention.

FIG. 6 shows a method of aligning construction holes using a construction hole alignment device, in accordance with one embodiment of the present invention.

FIG. 7 shows a lower end of a construction hole alignment device having stepped sections with conical-shaped outer calls, in accordance with one embodiment of the present invention.

FIG. 8 shows a perspective view of a construction hole alignment device having a flat surface, in accordance with one embodiment of the present invention.

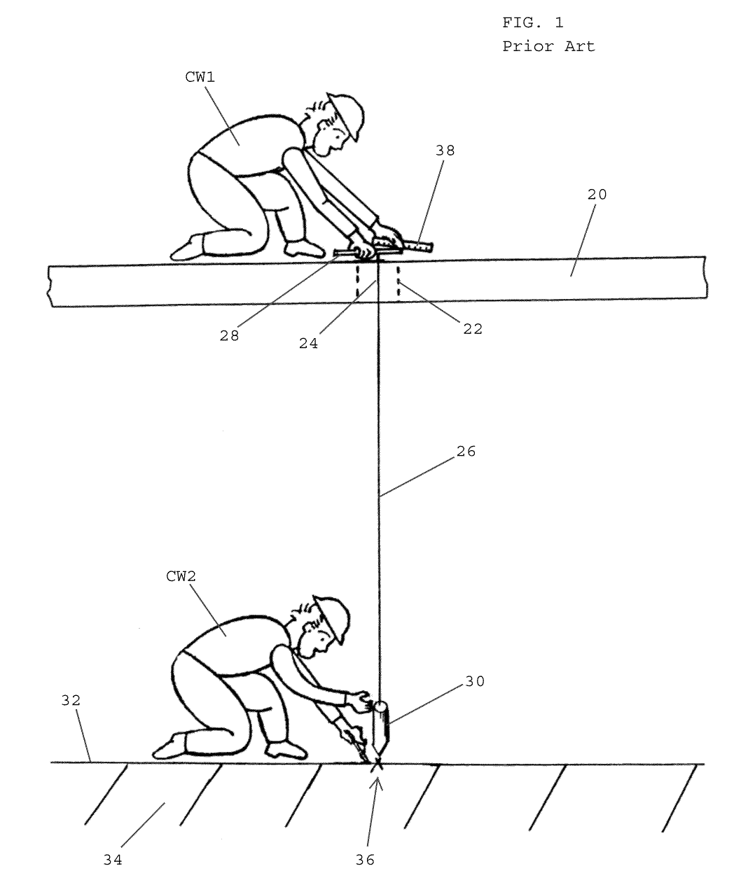

### DETAILED DESCRIPTION

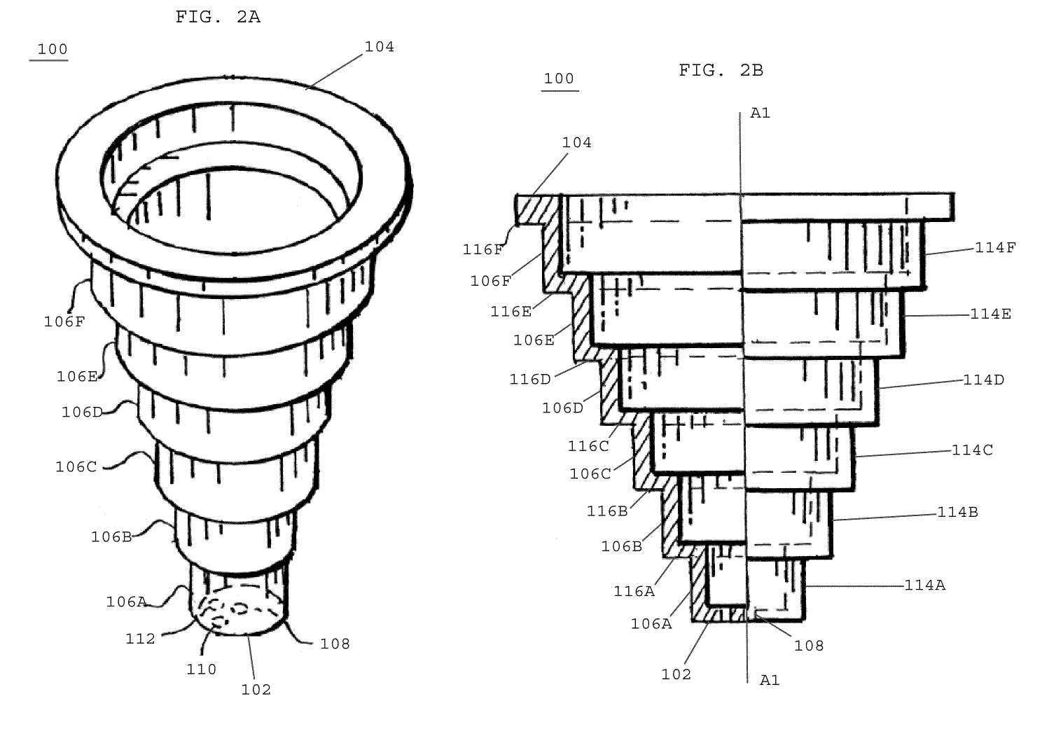

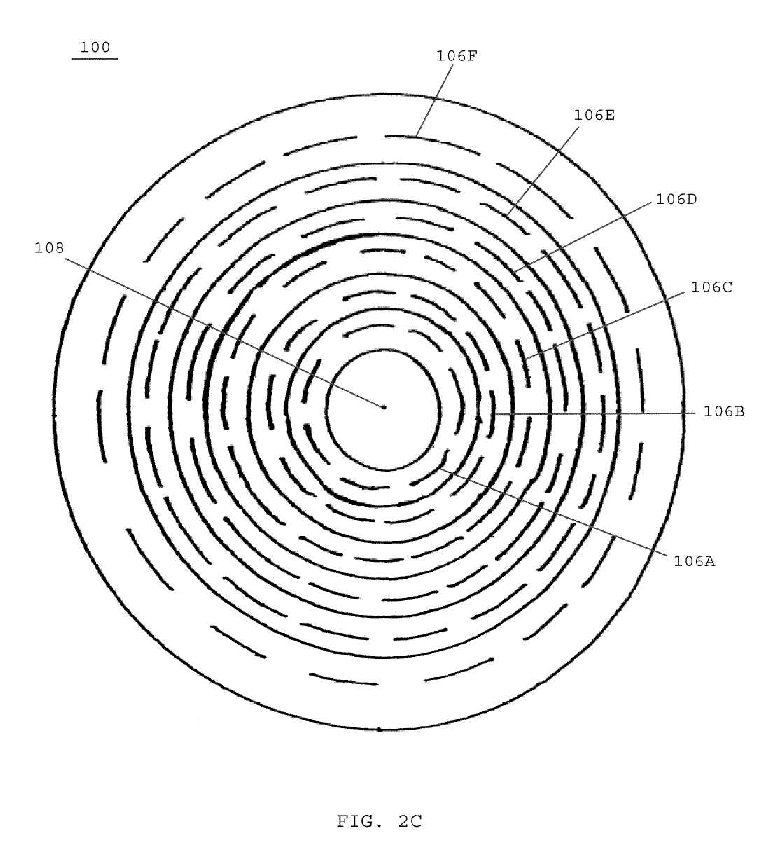

Referring to FIG. 2A, in one embodiment, a construction hole alignment device includes a tapered body 100. The tapered body 100 includes a first end 102, a second end 104, and a plurality of stepped sections 106A-106F that have progressively larger outer diameters. In one embodiment, the stepped sections have annular outer walls that may be cylindrical or conical in shape. In the embodiment shown in FIG. 2A, a second stepped section 106B has a larger outer diameter than a first stepped section 106A. In turn, a third stepped section 106C has a larger diameter than the second cylindrical section 106B. This pattern of larger stepped sections preferably continues between the first and second ends 102, 104 of the tapered body.

In one embodiment, the first end 102 of the tapered body 100 preferably has a closed end face, and may include a centering hole 108 formed in the closed end face. The centering hole 108 may be used for alignment purposes. In one embodiment, the centering hole 108 is used for hanging a string, such as a plumb bob string, therefrom. The centering hole may also be used as an aiming point for a laser alignment tool that projects laser or light beams. The closed lower end face also preferably includes a pair of auxiliary openings 110, 112 that may be used to pass string (e.g. plumb bob string) therethrough, and for making adjustments to the string. In one embodiment, the auxiliary holes 110, 112 may be used to adjust the length of a plumb bob string to compensate for different vertical heights between an upper floor and a lower floor of a multi-story building.

Referring to FIGS. 2A and 2B, in one embodiment, each of the stepped sections 106A-106F includes a cylindrical shaped outer wall 114A-114F. In one embodiment, each of the outer walls 114A-114F has a common center that is aligned with a central longitudinal axis A₁-A₁ of the tapered body 100. The tapered body 100 of the alignment device also preferably includes a plurality of horizontally extending flanges 116A-116F that preferably extend outwardly in horizontal directions from the upper ends of the respective outer walls 114A-114F.

As shown in FIG. 2B, in one embodiment, a first flange 116A extends between an upper end of a first cylindrical outer wall 114A and a lower end of a second cylindrical outer wall 114B. In turn, a second flange 116B extends between an upper end of the second cylindrical outer wall 114B and a lower end of a third cylindrical outer wall 114C. This pattern preferably continues to the sixth flange 116F located adjacent the upper end 104 of the tapered body. When the tapered body 100 is inserted into a construction hole, one of the flanges 116A-116F preferably engages the top surface of a floor for securing the tapered body in the construction hole with a portion of the tapered body projecting through the hole. In one embodiment, the flanges 116A-116F preferably insure that the tapered body 100 is level and/or properly oriented relative to the construction hole in which the body is inserted.

The tapered body 100 shown in FIGS. 2A and 2B has six vertically extending outer walls 114A-114F and six horizontally extending flanges 116A-116F. The tapered body shown in FIGS. 2A and 2B is merely a representative embodiment of the present invention. Other embodiments may have fewer or more outer walls 114 and flanges 116 and still fall within the scope of the present invention.

Referring to FIG. 2B, in one embodiment, the centers of each of the stepped sections 106A-106F are preferably in alignment with the central alignment hole 108 formed at the closed lower end 102 of the tapered body 100. As noted above, each of the stepped sections 106A-106F preferably has a different outer diameter for fitting in construction holes having different sizes.

In one embodiment, a construction hole alignment system preferably includes a set of tapered bodies having different sizes, e.g. small, medium and large. In one embodiment, a construction hole alignment system includes a small sized tapered body with outer walls having outer diameters that range between about 1-3 inches, e.g. 1.0 inches, 1.5 inches, 2.0 inches, 2.5 inches, 3.0 inches; a medium sized tapered body with outer walls having outer diameters that range between about 3-6 inches, e.g. 3.0 inches, 3.5 inches, 4.0 inches, 4.5 inches, 5.0 inches, 5.5 inches, and 6.0 inches; and a large sized tapered body with outer walls having outer diameters that range between about 6-9 inches, e.g. 6.0 inches, 6.5 inches, 7.0 inches, 7.5 inches; 8.0 inches, 8.5 inches, and 9.0 inches. The above-listed sizes and diameter ranges are merely exemplary in nature and are not intended to limit the scope of the present invention. During use, a construction worker may assess the size (i.e. the diameter) of a construction hole and then select the tapered body (e.g. small, medium, or large) that best fits the construction hole. Although the present invention is not limited by any particular theory of operation, it is believed that providing a construction hole alignment system with tapered bodies having different sizes will limit the overall length of each tapered body, which may be beneficial.

In one embodiment, each of the stepped sections 106A-106F is preferably dimensioned to fit construction holes having popular sizes. In one embodiment, the outer dimensions of the stepped sections are selected to provide about 0.015-0.050 inches of clearance between the outer wall of the stepped sections and the inner diameter of the construction hole.

In one embodiment, a construction hole alignment device includes one or more tapered bodies. The one or more tapered bodies may be made of rugged materials. The tapered bodies may be made of plastic, molded plastic, rubber, paper and/or combinations of plastic, rubber and paper.

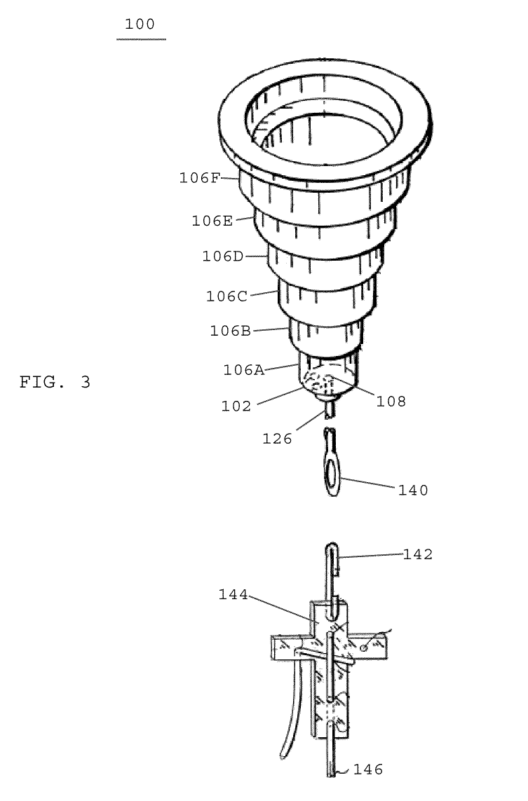

Referring to FIG. 3, in one embodiment, the tapered body 100 shown in FIGS. 2A-2C may be used with a conventional weighted plumb bob provided at a lower end of a string 126. In one embodiment, the first or lower end 102 of the tapered body 100 may be inserted into a first construction hole (not shown) formed in a first floor. The length of the a plumb bob string 126 may be pre-adjusted from the central alignment hole 108 of the tapered body for accommodating different vertical heights so as to position a loop 140 at a lower end of the plumb bob string 126 at about standard door height above a top surface of a lower floor level. The position of the loop 140 is preferably high enough to be out of a construction worker's way, but low enough to attach a hook 142 of a T-shaped structure 144 that may be used to both control and/or adjust the length of a second plumb bob string 146.

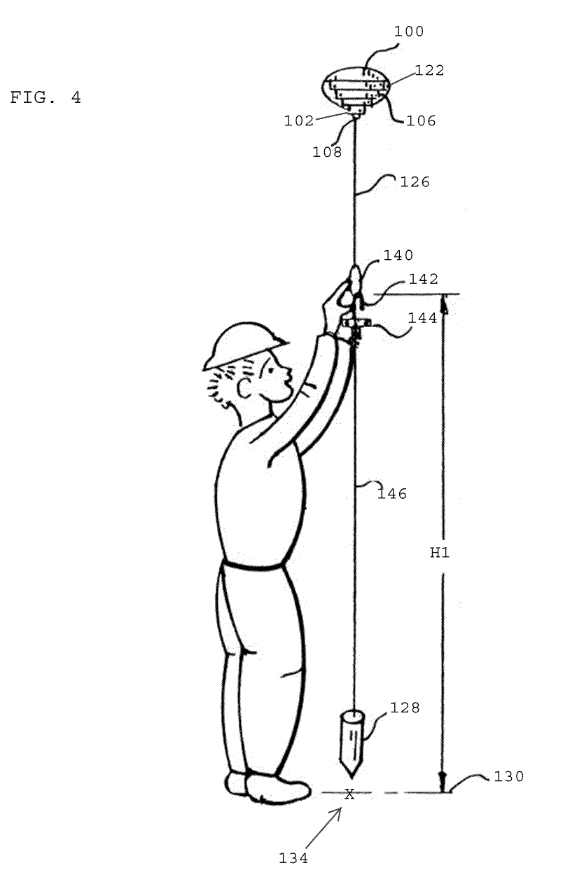

Referring to FIG. 4, in one embodiment, the first end 102 of the tapered body 100 is inserted into a first construction hole 122 formed in a first floor. The tapered body 100 is preferably advanced through the first construction hole 122 until one of the stepped sections 106 closely engages the inner diameter of the first construction hole 122. The flange associated with the stepped section in close engagement with the first construction hole 122 preferably overlies and extends beyond the outer perimeter of the first construction hole. When the tapered body 100 is properly positioned in the first construction hole, the centering hole 108 of the tapered body is preferably aligned with the center of the first construction hole 122. The alignment device preferably includes a first plumb bob string 126 that hangs from the centering hole 108 at the lower end 102 of the tapered body. In one embodiment, the length of the first plumb bob string 126 is fixed. The length of the first plumb bob string 126 may also be adjustable.

The lower end of the first plumb bob string 126 preferably includes a loop 140. FIG. 4 shows the hook 142 of the T-shaped structure 144 coupled with the loop 140 at the lower end of the first plumb bob string 126. The T-shaped structure 144 desirably enables the length of the second plumb bob string 146 to be adjusted to accommodate for different vertical heights between floors. In one embodiment, an upper end of the first string 126 may be passed through the first and second auxiliary holes 110, 112 (FIG. 2A) for making adjustments to the first string 126. In one embodiment, the T-shaped structure preferably enables the height H₁ between the loop 140 and the plumb bob 128 to be modified to accommodate for different vertical distances between upper and lower floors. After the plumb bob 128 is hung from the tapered body, a target location 134 for a second construction hole may be marked on the second floor 130. The target location 134 is preferably used to form the center of the second construction hole, which is preferably aligned with the first construction hole 122.

Referring to FIG. 5, in one embodiment, a laser plumb bob 228 may be used in conjunction with the construction hole alignment device shown and described above in FIGS. 2A-2C. After the tapered body 200 is inserted into a first construction hole 222, the laser plumb bob is hung from the lower end 202 of the tapered body 200. The plumb bob string may include a first plumb bob string 226 and a second plumb bob string 246. The lower end of the laser plumb bob 228 desirably projects a beam of light 250 on a target location 234 on a lower floor 230. In the embodiment of FIG. 5, the second plumb bob string 246 may have a fixed length because the laser plumb bob beam 250 locates the target location 234 on the lower floor 230 without requiring a pointed lower end of the plumb bob to be positioned closely to the lower floor 230.

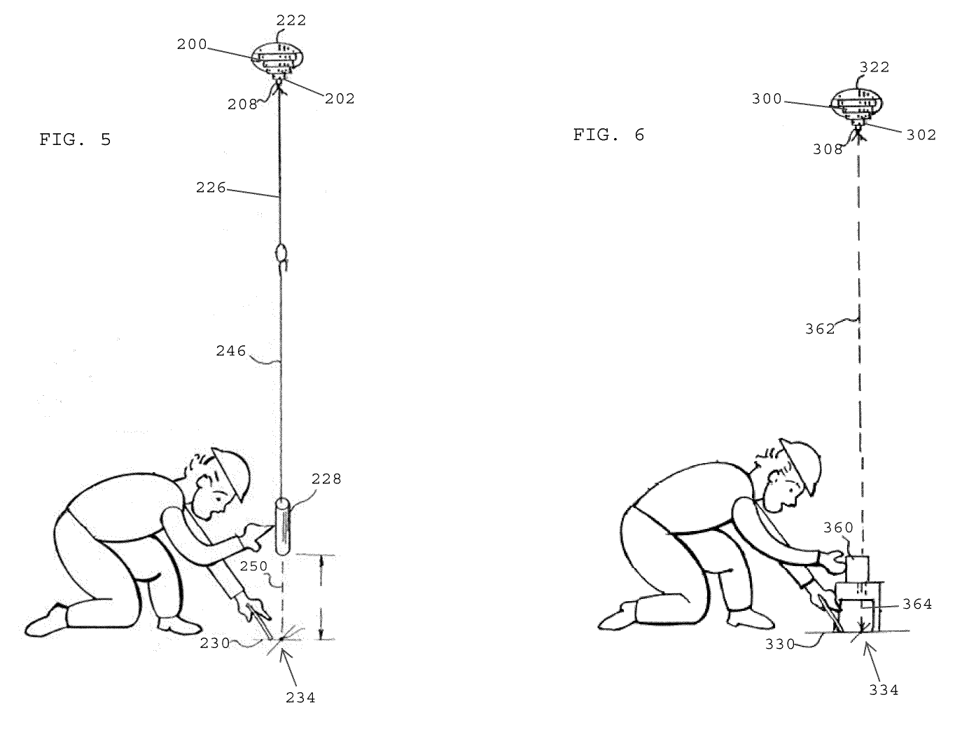

Referring to FIG. 6, in one embodiment, a construction hole alignment device may be used in conjunction with a laser alignment tool such as a double beam self-leveling laser tool 360. A tapered body 300 of the alignment device is preferably inserted into a first construction hole 322 so that a center alignment element 308 at the first end 302 of the tapered body is positioned in the center of the first construction hole 322. The laser tool 360 is preferably positioned atop a second floor 330 by a construction worker so that an upwardly projected light beam 362 is centered on the central alignment element 308 of the tapered body 300. The construction worker may then preferably remove his grip on the laser tool 360 until it levels and then mark the downwardly projected light beam's 364 position as a target location 334 on the lower floor 330. The target location 334 highlighted by the downward laser beam 364 desirably becomes the center for drilling a second construction hole in the second floor 330 that is in alignment with the first construction hole 322 in the upper floor.

Referring to FIG. 6, in one embodiment, a laser alignment tool may be positioned over the first construction hole 322 formed in the first floor, and a laser beam may be directed through the central alignment element 308 at the lower end of the tapered body 300 for marking the target location 334 on the second floor 330. In one embodiment, the device for generating the laser beam may be incorporated into the tapered body so that a worker need only place the tapered body in a first construction hole and activate the laser light on the tapered body for marking the target location on the second floor.

In the embodiment shown in FIG. 6, the laser tool 360 has been placed on a platform for purposes of clarity to show the downwardly projecting laser beam 364 striking the target location 334 on the second floor 330. In one embodiment, however, the laser tool 360 may be modified so that it is placed directly on the top surface of the second floor 330. In one embodiment, a laser tool may have an upwardly projecting laser beam and an alignment feature on the laser tool for aligning the target location with the first construction hole 322 on the upper floor

In one embodiment, the lower end of a construction hole alignment device is preferably inserted into a first construction hole formed in an upper floor. The centering device is advanced until an outer wall of one of the cylindrical shaped sections closely matches the inner diameter of the first construction hole. At that point, the central alignment hole at the lower end of the construction hole alignment device is preferably located at the center of the first construction hole.

In one embodiment, the length of the plumb bob string may be pre-adjusted so as to position the loop about standard door height above a lower floor level. This height is preferably high enough for the loop to be out of the construction worker's way, but low enough to attach a hook with a fixed length of string and a weighted plumb bob thereto. The fixed length of string is preferably a length that suspends the weighted plumb bob at a convenient height above the lower floor level. The construction worker at the lower floor level may use the plumb bob to mark a target location on the lower floor. The target location preferably represents the center position of the second construction hole that is in alignment with the center of the first construction hole above. Thus, a single construction worker may, without requiring the assistance of a second construction worker, mark the centers of a plurality of construction holes with high accuracy.

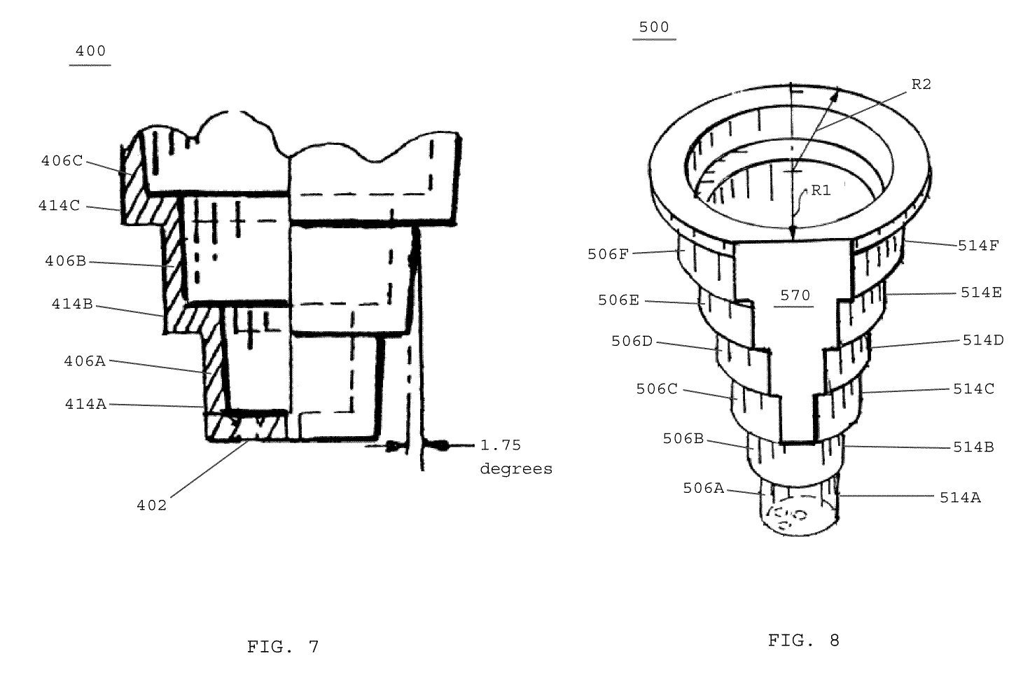

Referring to FIG. 7, in one embodiment, a construction hole alignment device includes a tapered body 400 having conical shaped outer walls 414A-414C that preferably taper outwardly between lower and upper ends of each stepped section 406A-406C. In one embodiment, the outer walls 414A-414C taper outwardly at about 1.75°. In one embodiment, the outer walls 414A-414C have a height of about 0.60-0.65 inches so that the upper diameter dimension accommodates for the lower diameter's dimension of 0.03 inch clearance. As is known to those skilled in the art, construction holes may have a clearance of about ⅛ inch or less. As a result, the tapered body 400 of the present invention will provide sufficient accuracy. The tapered design of the stepped sections 406A-406C shown in FIG. 7 desirably enables a plurality of the alignment devices to be nested one inside the other to provide for stacked storage of the tapered bodies.

The sizes and dimensions listed above are merely exemplary in nature. In one embodiment, a construction hole alignment system includes at least one tapered body having outer wall sections that taper between about 1-5 degrees, having wall heights of between about 0.35-0.65 inches and preferably having a clearance with construction holes of about 0.015-0.05 inches.

FIG. 8 shows a construction hole alignment device including a tapered body 500 having a plurality of stepped sections 506A-506F extending between a first end 502 and a second end 504 of the body 500. In one embodiment, the stepped sections 506A-506F of the tapered body 500 preferably define cylindrical shaped outer walls 514A-514F having different diameters. The outer walls of at least some of the stacked cylindrical sections have a flattened surface 570 that extends at least part of the length of the tapered body. The flattened surface 570 desirably define a smaller radius R₁ than the larger radius R₂ of the annular section, which allows the tapered body 500 to be inserted in a construction hole with its flat surface 570 facing an obstruction that is closer to the tapered body than its larger radius R₂. For example, the flattened surface 570 preferably enables the tapered body 500 to be inserted into a construction hole that is located close to a vertical wall.

The headings used herein are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

While the foregoing is directed to embodiments of the present invention, other and further embodiments of the invention may be devised without departing from the basic scope thereof. For example, the present invention contemplates that any of the features shown in any of the embodiments described herein may be incorporated with any of the features shown in any of the other embodiments described herein and still fall within the scope of the present invention.

What is claimed is:

1. A construction hole alignment device comprising:
a tapered body having a smaller diameter first end, a larger diameter second end, and a series of stepped sections having progressively larger diameters extending between the first and second ends of said tapered body;
said tapered body having a central axis extending between the first and second ends thereof, wherein the first end of said tapered body defines a center that is in substantial alignment with the central axis of said tapered body.

2. The alignment device as claimed in claim 1, wherein each of said stepped sections has an outer wall.

3. The alignment device as claimed in claim 2, wherein at least one of said outer walls has an annular shape.

4. The alignment device as claimed in claim 2, wherein at least one of said outer walls has a cylindrical shape.

5. The alignment device as claimed in claim 2, wherein at least one of said outer walls has a conical shape.

6. The alignment device as claimed in claim 2, wherein said outer wall of at least one of said stepped sections has a first curved section and a second substantially flat section.

7. The alignment device as claimed in claim 6, wherein said first curved section defines a first distance from the central axis and said second substantially flat section defines a second distance from the central axis, and wherein the first distance is greater than the second distance.

8. The alignment device as claimed in claim 1, wherein the smaller diameter first end of said tapered body has a substantially closed end face and the center at the first end includes a central opening aligned with the central axis of said body.

9. The alignment device as claimed in claim 8, further comprising:
a string coupled with the central opening at the first end of said tapered body; and
a plumb bob secured to said string for hanging said plumb bob from the first end of said tapered body.

10. The alignment device as claimed in claim 8, wherein said string has a length that is adjustable.

11. The alignment device as claimed in claim 8, wherein said plumb bob is selected from the group consisting of weighted plumb bobs, and laser plumb bobs.

12. The alignment device as claimed in claim 1, wherein said tapered body comprises:
a first stepped section including a first annular outer wall having a first diameter;
a second stepped section including a second annular outer wall having a second diameter that is greater than the first diameter of said first annular outer wall;
a first flange interconnecting an upper end of said first annular outer wall and a lower end of said second annular outer wall.

13. The alignment device as claimed in claim 12, wherein said tapered body further comprises:
a third stepped section including a third annular outer wall having a third diameter that is greater than the second diameter of said second annular outer wall;
a second flange interconnecting an upper end of said second annular outer wall and a lower end of said third annular outer wall.

14. The alignment device as claimed in claim 1, wherein at least two of said stepped sections have respective centers that are aligned with the central axis of said tapered body.

15. The alignment device as claimed in claim 1, further comprising:
a light emitting tool adapted for placement on a surface below the first end of said tapered body;
said light emitting tool having a first light emitting element for projecting a first light beam in a first direction and a second light emitting element for projecting a second light beam in a second direction that is opposite the first direction.

16. A construction hole alignment device for aligning a first construction hole formed in a first floor with a second construction hole to be formed in a second floor, said alignment device comprising:
a tapered body having a smaller diameter first end adapted for insertion into said first construction hole, a larger diameter second end, and a series of stepped annular shaped sections having diameters that are progressively larger between the first end of said tapered body and the second end of said tapered body;
said body having a central axis extending between the first end of said tapered body and the second end of said tapered body, wherein the first end of said tapered body includes a center that is in substantial alignment with the central axis of said tapered body.

17. The alignment device as claimed in claim 16, further comprising flanges interconnecting adjacent ones of said stepped sections, wherein said flanges are substantially parallel with one another and extend outwardly away from the central axis of said tapered body.

18. The alignment device as claimed in claim 16, further comprising a plurality of tapered bodies having substantially open second ends, wherein a first end of a first tapered body is insertable into a substantially open second end of a second tapered body for stacking at least two of said tapered bodies atop one another.

19. A method of aligning construction holes comprising:
forming a first construction hole in a first floor of a building;
inserting a tapered body into said first construction hole, said tapered body having a smaller diameter first end, a larger diameter second end, a series of stepped sections having progressively larger diameters extending between the first and second ends of said tapered body, and a central axis extending between the first and second ends of said tapered body, wherein the first end of said tapered body includes a center that is in substantial alignment with the central axis of said tapered body;
inserting the first end of said tapered body into said first construction hole until an outer surface of one of said stepped sections closely engages an inner diameter of said first construction hole;
after inserting said tapered body into said first construction hole, using the center at the first end of said tapered body for defining a target location on a second floor of said building that is substantially aligned with said first construction hole.

20. The method as claimed in claim 19, further comprising:
providing a plurality of tapered bodies, forming a plurality of first construction holes in the first floor of said building;
inserting one of said tapered bodies in each of said first construction holes for defining target locations on said second floor that are aligned with said first construction holes.

21. The method as claimed in claim 19, further comprising:
hanging a first string from the center at the first end of said tapered body;
hanging a second string from said first string, wherein said second string has a plumb bob secured to a lower end thereof.

22. The method as claimed in claim 21, wherein said second string has a fixed length or an adjustable length.
